(19) United States
(12) Patent Application Publication
(10) Pub. No.: US 2004/0117272 A1
(43) Pub. Date: Jun. 17, 2004

(54) System for browsing stored entertainment content extracted from a different medium

(76) Inventor: Yaz Shehab, New York, NY (US)

Correspondence Address: Niro, Scavone, Haller & Niro, Suite 4600, 181 West Madison Street, Chicago, IL, 60602, US

(21) Appl. No.: 10/462,124

(22) Filed: Jun. 13, 2003

Related U.S. Application Data
(63) Continuation of application No. 09/658,050, filed on Sep. 8, 2000, now abandoned.

(51) Int. Cl. G06F 17/60

(52) U.S. Cl. 705/27

(57) ABSTRACT

A system for providing access by customers of a retail store to individual tracks from plural CDs includes an in-store server computer for storing a plurality of the individual CD tracks and auxiliary visual information related to the CDs from which they were extracted. Plural computers in the store communicate with the in-store server computer for sending commands thereto and receiving individual CD tracks therefrom in response to a selection made by store customers using the client computers. Each client computer includes an interface unit for reproducing the selected CD track through headphones and displaying the auxiliary information on a display. The retail store is one of several subscribers to the overall system run by a proprietor that updates the in-store subsystem using a central repository. The system proprietor extracts individual tracks from plural CDs and generates auxiliary information such as graphic and video files representing CD covers and advertising, and stores them in a main repository server computer. The in-store subsystems are periodically updated using the information provided from the central repository.

### BACKGROUND OF THE INVENTION

1. Field of the Invention

The present invention relates to a system for browsing stored entertainment content extracted from a different medium, and more particularly, to a system that permits a retail store customer to access selected items of digitally stored information such as individual tracks from multiple compact audio discs.

2. Description of Related Art

For all the recent technological advancement in the music-industry, the experience of a customer in a retail record store has changed very little. The typical in-store retail music environment is fundamentally passive in that the retailer has minimal participation in a customer's purchase selections. The retailer in essence relies on the creation of customer interest and demand before the customer comes to the store.

Retail music stores have added listening stations where customers can listen to tracks of compact audio discs (CDs). Such listening systems have proved useful up to a point, but their usefulness is limited for a number of reasons.

For one thing, they are able to play, and thus promote, only a limited number of titles pre-selected by the retailer. The customer typically does not have access to more than a few CDs at any one listening station, and in known systems he or she must move to another part of the store to listen to music in a different genre. The reason for these shortcomings has to do with the necessity of physically changing CDs at the CD player being used for a particular listening station. In addition, the customer's experience at a listening station is very one-dimensional in that the only information available is the music itself. There is no way to offer additional information about the music, the artist or other CDs the listener might like, just to name a few marketing tools that the retailer might find useful if a way was available to employ them.

Another relatively recent addition to some music stores is a self-service directory kiosk. Basically, this feature enables a customer to look up ordering information about a particular title, or find out where it is in the store, instead of having to ask a store clerk. But that adds very little to the ability of the retailer to make the most of a customer's visit to the store, both for the customer and the retailer.

Apart from having access to listening stations and directory kiosks, the experience of a customer in a retail music store has not changed in decades. As a result, traditional retailers are threatened by web-based competition. However, close inspection reveals that most music web sites do little more than replicate the traditional in-store experience. They may have lists of particular albums, which is equivalent to a feature display or on-sale rack in a store. There are genre sections, which are the equivalent of the self-service directory in a store. Finally, a limited number of titles are offered for downloading and listening, just like at a listening station at a store.

Physically, retail music store have been configured on the model of a book store, with rows of warehouse-like bins filled with records, CDs and/or tapes. That has also hampered customers' ability to comfortably browse and choose music. Many stores are providing in-store coffee ships and lounge areas to make the store environment more attractive to customers. It would be advantageous for the store's customers if there were a comprehensive music selection system that could be made a part of this total in-store experience. In addition, it would increase the retail traffic in the store.

An attempt at such a system is disclosed in U.S. Pat. Nos. 5,237,157 and No. 5,963,916. The system in these patents involves an in-store kiosk where a listener can access pre-selected partial samples from CDs. The samples are digitally stored at the kiosk and the user accesses them by entering a subscriber code that identifies the user. In another embodiment, the samples are accessed from the kiosk by logging onto a web site where the samples are stored.

Although this expands somewhat on the “listening station” concept, it still has significant limitations. For one thing, it only makes available partial samples from pre-selected CDs. This severely limits its ability to serve as a listening station because a user only has access to partial samples from CD tracks. In addition, the system's ability to serve effectively in different types of music stores is limited because it fails to include any way of matching the samples that are available with a particular store's inventory. Another shortcoming of the system disclosed in these patents is the complexity of the graphical user interface by which the user navigates the system. It involves numerous screens and menu choices that a user who is uncomfortable with computer-like navigational techniques could find confusing.

At bottom, however, the system disclosed in these patents suffers from the fact that it is essentially based on the paradigm of existing web-based music sites, both in the self-contained in-store embodiment and in the embodiment in which the music web site is accessed by a computer that happens to be located in a retail music store. While that is different from traditional in-store listening stations, and in some ways is an improvement on them, it still fails to give the music consumer a completely new in-store experience when shopping for music, while enabling the store proprietor and advertisers to further their interests to the maximum extent possible.

### SUMMARY OF THE INVENTION

It is an object of the invention to avoid the shortcomings of the prior art as discussed above and provide in-store stations where customers have inadequate access to the store's entertainment content.

In accordance with one aspect of the present invention, a system for providing access to individual ones of plural discrete groups of digital data containing entertainment content, each group of digital data representing a corresponding discrete group of entertainment content extracted in its entirety from a different medium, comprises:

a server computer for storing a plurality of the groups of digital data, the server computer being under the control of software for accessing each group of digital data, and at least one client computer communicating with the server computer for retrieving at least one group of digital data therefrom, the client computer including an interface unit for reproducing the entertainment content from the retrieved group of digital data and being under the control of software for enabling a user to retrieve a specified group of digital data.

In a more specific embodiment, each group of digital data comprises an audio track extracted from a compact audio disc for reproduction on stereo headphones included in the interface unit, and the interface unit includes a monitor for displaying visual information related to the CD track being reproduced. That visual information includes graphic information such as a depiction of the compact audio disc cover and advertising related to the compact audio disc selected for retrieval. In particular regard to the advertising, an advertiser can thus specify which compact audio discs to associate with its advertising, thus providing a powerful marketing tool.

In another aspect of the invention, the screen displays a number of compact audio discs related to the selected disc. An algorithm is used to generate the list of related discs. As a consequence the particular related discs can change based on the nature of different users' selections over time.

In accordance with another aspect of the invention, a system for providing access by customers of a retail store to individual ones of plural discrete groups of digital data containing entertainment content extracted from a different medium comprises:

a central repository including:

a repository server computer for storing a plurality of the groups of digital data and auxiliary digital data containing auxiliary information related to each of the groups of digital data, the production server being under the control of software for associating each of the groups of digital data with related auxiliary information,

means for generating the auxiliary digital data for storage by the production server computer, and

means for extracting the entertainment content from the different media for storage as the groups of digital data: by the repository server computer; and

at least one in-store subsystem for accepting the groups of digital data and the auxiliary digital data from the central repository, each in-store subsystem including:

an in-store server computer for storing a plurality of the groups of digital data, the in-store server computer being under the control of software for accessing each of the groups of digital data, and

at least one client computer communicating with the in-store server computer for retrieving at least one the group of digital data therefrom, the client computer storing the auxiliary digital data and including an interface unit for reproducing the entertainment content from the retrieved group of digital data and being under the control of software for enabling a user to retrieve a specified group of digital data, wherein the interface unit includes a monitor for displaying the auxiliary information associated with the specified group of digital data.

In accordance with yet another aspect of the invention, a user interface unit used in a system for providing access to individual ones of plural discrete groups of digital data containing entertainment content and related visual information associated therewith, which interface unit is under the control of software on a computer remote from the interface unit, comprises a monitor for displaying visual information stored on the computer, a listening device for reproducing said audio information stored on said computer, a touchpad device having an inputting surface for providing signals to the computer for designating information for display on the monitor and for reproduction by the listening device, and an enclosure having a body portion containing the monitor, an apron integral with the body portion mounting the touchpad input device with its inputting surface flush with an upper surface of the apron below the body portion, and a listening device mount holding the listening device in position for use, wherein the enclosure encloses the touchpad device and the monitor.

### BRIEF DESCRIPTION OF THE DRAWINGS

The objects of the invention will be better understood from the detailed description of its preferred embodiments which follows below, when taken in conjunction with the accompanying drawings, in which like numerals refer to like features throughout. The following is a brief identification of the drawing figures used in the accompanying detailed description.

FIG. 1 is a schematic representation of the components of a browser system in accordance with one embodiment of the present invention.

FIG. 2 is a schematic representation of an in-store subsystem that is part of the browser system depicted in FIG. 1.

FIG. 3 shows a sample screen on the monitor of a client computer during operation by a customer of the in-store subsystem shown in FIG. 2.

FIG. 4 shows the sample screen depicted in FIG. 3 showing two examples of additional information about displayed items that is available by resting the screen cursor on those items.

FIG. 5 shows a sample screen depicted in FIG. 2 showing a menu comprising all of the tracks of an audio section to which the user is currently listening.

FIG. 6, comprising front view FIG. 6A, side view FIG. 6B and bottom view FIG. 6C, illustrates an enclosure for an in-store user interface unit as depicted in FIG. 2.

### DETAILED DESCRIPTION OF PREFERRED EMBODIMENTS

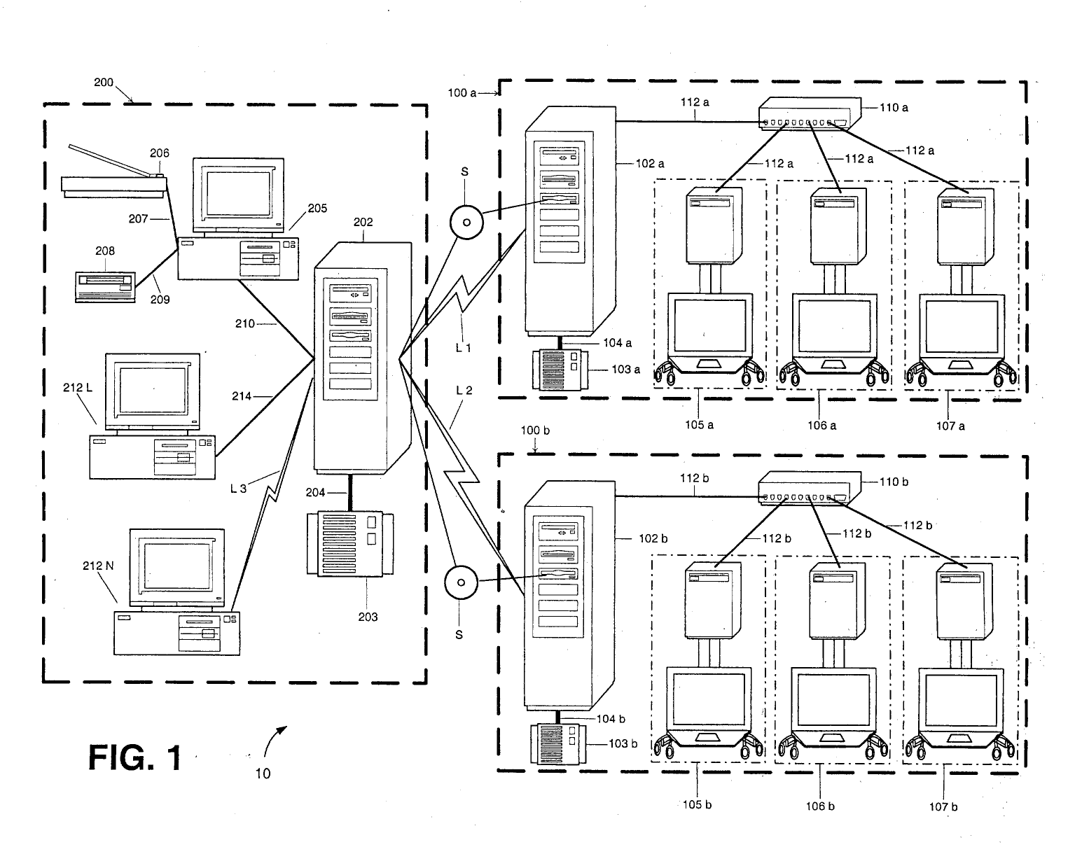

Referring to FIG. 1, an overall browser system 10 includes two in-store subsystems 100a and 100b and a separate central information repository 200, typically in a remote location. The system 10 contemplates a large number of retail stores that subscribe for participation in the system, and that FIG. 1 depicts two such subsystems for illustrative purposes only.

Information is exchanged between the in-store systems 100 and the central repository 200 by a data link that is remotely accessible, such as through ultrafast telecommunication lines L1 and L2, or by using fixed storage media S sent physically to the in-store subsystems 100 from the central repository 200. This data transfer is described in more detail below.

Each in-store subsystem 100 includes one or more local server computers. In the present embodiment, each subsystem 100 includes a local server computer 102. It will be appreciated that in this description, components of the different subsystems 100 shown in FIG. 1 are denoted by the suffixes “a” and “b.” References in the discussion of FIG. 1 that follows to numerals without suffixes will be understood to be to like components of the respective subsystems 100a and 100b.

Each local server 102 will have installed thereon suitable operating system software. It has been found that RedHat Linux operating system software is particularly suited for this purpose because its source code can be modified to remove operating features not needed for the present purpose and thus render the operating system more robust and reliable. Currently, it is contemplated that each local server will use a 700 MHZ central processing unit, such as an Intel Pentium III processor. Each local server computer 102 should have at least 128 MB of RAM and an internal or external hard drive disc array with sufficient total storage capacity to accommodate the audio, video, graphics and other media, such as animation files, used by the subsystem.

The disc storage required by a local server computer 102 in the present embodiment is provided by a conventional RAID device 103. This type of device, known by its acronym for “redundant array of inexpensive discs,” is familiar to those skilled in the field of computer systems. It is connected to the server 102 by a suitable cable 104. The RAID device may interface with the server computer 102 through a conventional SCSI connection. It is preferable that the cable 104 be an internal ultra-2 LVD cable, such as a TMC ultra-2 LVD cable with end termination.

The RAID devices are typically implemented using 18 GB ultra-2 SCSI (LVD) Quantum Atlas-V-18LWS discs, or other discs of comparable quality. It is expected that further improvements in disc capacity will be made over time, and such improvements can be readily incorporated into the present system to improve its performance. In any event, the in-store server 102 typically uses a number of discs, at least one of which is a parity disc. In that configuration the system can survive one disc crash and automatically restore any lost data on another disc. This not only increases the array's mean time to failure, but it is also extremely fast.

It will be understood that the specifications for particular components of the system described throughout this discussion are merely representative. Those skilled in the art will readily appreciate that the specifications may be changed in accordance with the particular requirements of an individual system and its desired performance characteristics.

Each local server computer 102 stores on its hard drive disc array a plurality of audio files corresponding to a selection of a substantial number, preferably all, of the store's inventory of CDs. It is an important feature of the present invention that the audio files stored on the in-store server can represent the entire 15,000 to 25,000 CD inventory of a typical music store. In the present embodiment, each CD would represent about 50 MB of digital audio information.

A local server computer 102 with the specifications noted above will serve numerous, theoretically hundreds, of client computers. However, to simplify this description, the local in-store server 102 is shown in FIG. 1 as communicating with only three client computers 105, 106 and 107. That communication is through a 10/100 MB switch 110 and category 5 ethernet network cables 112. The server computer 102 stores the necessary software to communicate with the client computers and perform all of the functions described below.

The switch 110 is a standard hardware item, and can be implemented with a Netgear Model FS-108 Fast Ethernet switch. It transmits digital information from the server computer at 100 MB/sec for acceptance by the client servers at 10 MB/sec.

The switch 110 has sufficient bandwidth to provide the subsystem 100 with a large degree of versatility in terms of its audio capabilities. The switch 110 and cables 112 transmit audio information and processing http requests between the in-store server 102 and the client computers 105, 106 and 107. Each single compressed 44 KHz audio channel occupies 64 kilobits per second. For two-channel (stereo) sound, the compressed audio stream therefore occupies 128 kilobits per second. That means that each switch 110 is utilizing less than 2% of its 10 MB/sec capacity. Accordingly, there is ample bandwidth for more information, such as the additional audio information that would be used with multi-channel surround-sound.

Alternatively, or in addition, the spare bandwidth could also be used for other purposes, such as video delivery from the server in an alternate embodiment of the system. It could also permit the user to take advantage of other information transfer protocols, such as browsing the internet via the in-store server, at the same time he or she is listening to audio. Thus, web-based information could be accessed as well as the entertainment content stored on the server 102.

The ethernet-based network described above can readily support more than 600 clients per server, which means that a particular in-store subsystem with a limited number of client computers can be scaled up to a larger subsystem at a later time.

Moreover, the in-store local area network can be implemented in other ways, such as by an ATM (asynchronous transfer method) based network. Those skilled in this art are familiar with that type of data transfer protocol, in which information is organized into cells that are transmitted asynchronously, in the sense that the recurrence of cells containing information from an individual system user is not necessarily periodic. The local in-store network can also be implemented by wireless connections.

As noted above, each in-store local area network subsystem 100 can include as many client computers as is desired. Those skilled in the art will be able to provide store servers in the proper number and with the proper specifications depending on the desired performance and makeup of the system. FIG. 1 illustrates subsystems having only one local server each solely for ease of illustration and explanation.

Hardware suitable for use as the client computers 105, 106 and 107 is an Intel Celeron or AMD K-6-II processor running at 500 MHZ or more. It has been found that BeOS is the most functional operating system software for the client computers. BeOS is a preferred operating system because of its multimedia capabilities, resulting from its multithreaded design which allows multiple media threads to be simultaneously displayed and managed on a single computer. Each central processing unit should include at least 128 MB of RAM and a hard drive with sufficient capacity to store the information discussed below. Again, those skilled in the art will find it routine to choose a client computer with the proper specifications to fulfill the requirements described herein.

Each client computer 105, 106 and 107 stores on its hard drive a plurality of graphics files in a suitable format. These files depict the “album” cover under which CDs having tracks stored in the server computer 102 are sold. As with the audio files discussed above, the client computer will typically have graphic files for all of the store's inventory. Each CD cover typically comprises a JPEG file of about 10 KB.

In addition to the CD cover graphics files, each client computer hard drive stores files containing textual and/or video information such as reviews or other information about a CD and advertising or similar promotional information. The total disc space occupied by these files is about 2.5 GB, with the actual space of course depending on the amount of cached data and advertising. Video files will be in a format that permits them to be displayed on a monitor associated with each client computer, in a manner described in more detail below. For example, the video format can be in Quciktime or AVI, which are conventional video formats, using Intel's Indeo 5.1 compression codec or Apple Cinepack compression codec. Video information can be stored in a variety of resolutions, but typically it will be either in 15 or 30 frames-per-second resolution.

Finally, the hard drive for each client computer stores software for carrying out the functions of the system and its various parts as described in more detail below.

If desired, a local in-store subsystem may have multiple server computers, each connected to multiple client computers as discussed above.

The central information repository 200 includes a main repository server computer 202. In the present system it will use RedHat Linux as its operating system software for the reasons discussed above. It is contemplated that the main repository server will use a 450 MHZ single processor, multi-processor capable, central processing unit, such as an Intel Xeon processor. The server 202 should have at least 256 MB of RAM. Storage space for the repository server 202 is provided by a RAID disc storage device 203 connected to the repository server 202 by a cable 204, in a manner similar to that discussed above in connection with the RAID device 103 and cable 104 used in the in-store subsystems 100.

The server 202 functions as a master repository for information to be used by plural in-store subsystems 100. It stores on the RAID device 203 a plurality of audio files, graphics files representing CD covers, information about-the CDs, and advertising information, for the purposes described in more detail below. It also stores software for performing the functions described below.

The central repository server 202 is connected to the in-store servers 102 by telecommunications links L1 and L2 to enable the system proprietor to monitor the performance of the individual in-store subsystems. That is, software resident on the repository server 202 and the in-store servers 102 provides the repository server with information on usage and performance of each in-store subsystem. That information can be used by the system proprietor better to tailor each individual in-store subsystem to the subscriber's needs and to provide better service to advertisers using the system in the manner described below. For example, it can be used to monitor any desired aspect of the system, such as the number of times certain CDs are played or particular advertising is accessed. One particularly advantageous application is that the CDs with which certain advertising is associated can be changed from the central repository based on updated information from the advertising purchaser.

The central information repository 200 also includes an encoding computer 205. A computer suitable for this purpose is a Macintosh G-3 with a 450 MHZ processor using Xing's Audio-Catalyst software v.2.0. The audio information is encoded in MP3 format (that is, MPEG1-level 3), in stereo at 128 KBS, although other compression alternatives are possible.

A color scanner 206, such as a Hewlett-Packard ScanJet 8 model, is used to scan front and back CD covers, and any images desired to be captured from materials inside the CD case, at a resolution of, say, 180×180 pixels per inch and create a computer file containing about 10 KB of data in JPEG format for each image. The scanner 206 is under the control of the encoding computer 205 through the cable 207. Each CD cover file is assigned an identifier used to associate it with audio files extracted from that album.

The audio files are extracted from the CDs using a high-speed CD reader 208, such as a Mitsubishi 44X CD-ROM Reader, under the control of the encoding computer 205 through a cable 209. The CD reader 207 converts audio tracks on standard CDs into computer files in a suitable format, presently contemplated as being MP3 for the present system. An audio file in MP3 format will be about 50 MB of data per single CD, as noted above. The encoding computer 205 creates plural files of digital data, each representing a track of the CD, and an identifier that associates each such file with the CD from which it was extracted.

FIG. 1 shows the encoding computer 205 connected to the main repository server 202 by a category 5 ethernet network cable 210. Under the control of its application software, the repository server 202 stores on the RAID device 203 the audio files representing CD tracks and the CD-cover graphics files received from the encoding computer, as noted above.

It is also possible to create audio and graphics files at locations remote from the central repository 200 and transmit them electronically by telecommunication or physically transport them on a storage medium such as a disc (not shown) for storage by the main repository server 202. In any case, the main repository server 202 stores the files from the encoding computer 205 in a database on the RAID device 203 along with the identifiers that associate them with particular CDs.

The repository server 202 also stores certain auxiliary or discretionary information about the CDs whose tracks have been extracted by the encoding computer 205. In the present embodiment, this discretionary information includes information in the form of text and/or graphics that is descriptive of the content of the CDs from which the tracks have been extracted and stored on the main repository server's hard drive, and advertising that typically will include text, graphics and/or video files.

The descriptive information typically comprises reviews or recommendations by professional critics concerning a CD. It can be created especially by music critics employed by the proprietor of the system according to the present invention, or the system proprietor might purchase access to reviews of other critics or music magazines for which they work, or a combination of both and other sources. Reviewers may also be associated with different subscriber retail stores or chains of stores so that each subscriber can tailor the information to its own customer base.

A plurality of sources for this discretionary information is schematically depicted in FIG. 1 by the computers 212L and 212N. In practice, the text and/or graphic information relating to the CD content is generated by plural authors and magazines. The computer 212L is depicted as being connected to the repository server by a cable 214, such as a category 5 ethernet network cable as described above. It is possible to constitute a network for providing this information as one or more computers connected by cables to the repository server 202 at the same location.

However, there may also be a network of remotely located computers 212N, connected over the internet to the repository server 202 through a telecommunications link L3. A plurality of sources for the discretionary information can communicate over the net-based computers 212N through secure, password protected links. For example, a music critic might have a computer 212N at a remote location and, knowing the proper password, be capable of adding to the repository server database a review associated with a CD stored on the repository server's disc storage.

It will be immediately apparent that any device or mechanism for providing the auxiliary information in digital form to the repository is equivalent to the computers 212L and 212N.

As with the audio files and the CD covers, the repository server stores the files of the discretionary information in a database with identifiers that associate them with particular CDs.

The discretionary information can also include animation files stored in a format such as shockwave, associated with a particular a particular CD or simply available generally to the system for display by monitors associated with the in-store client computers, in a manner discussed below.

Finally, the discretionary information includes information that advertisers pay the system proprietor to include on the system for display on the in-store client computer monitors. The advertising is typically supplied directly by the advertiser in a suitable format and size depending on how it is to be displayed. For example, the format may be JPEG or GIF for still images or a suitable compressed video format, such as AVI, as mentioned above, or Quicktime, for animated advertising.

Those skilled in the art will recognize that any mechanism by which the advertising files are inserted into the overall system is equivalent to the means described above.

It is an important aspect of the present invention to enable advertisers to match their advertising with certain music. For example, a manufacturer of products for people in a certain age group might want the system to associate its advertising with music known through market research to be popular with people in that age group. Then, when such music is played by a user at a retail store the designated advertising will be displayed on the in-store client computer monitor, as described in detail below. This ability to target advertising as desired by sponsoring advertisers is important because it is contemplated that it will provide sufficient revenue to the system proprietor to enable placement of in-store subsystems at less cost to the store than would otherwise be required to finance the entire system.

In any event, those skilled in the art will be able to provide one or more main repository servers in the proper number and with the proper specifications depending on the desired performance and makeup of the system. FIG. 1 illustrates a system having only one such server solely for ease of illustration and explanation.

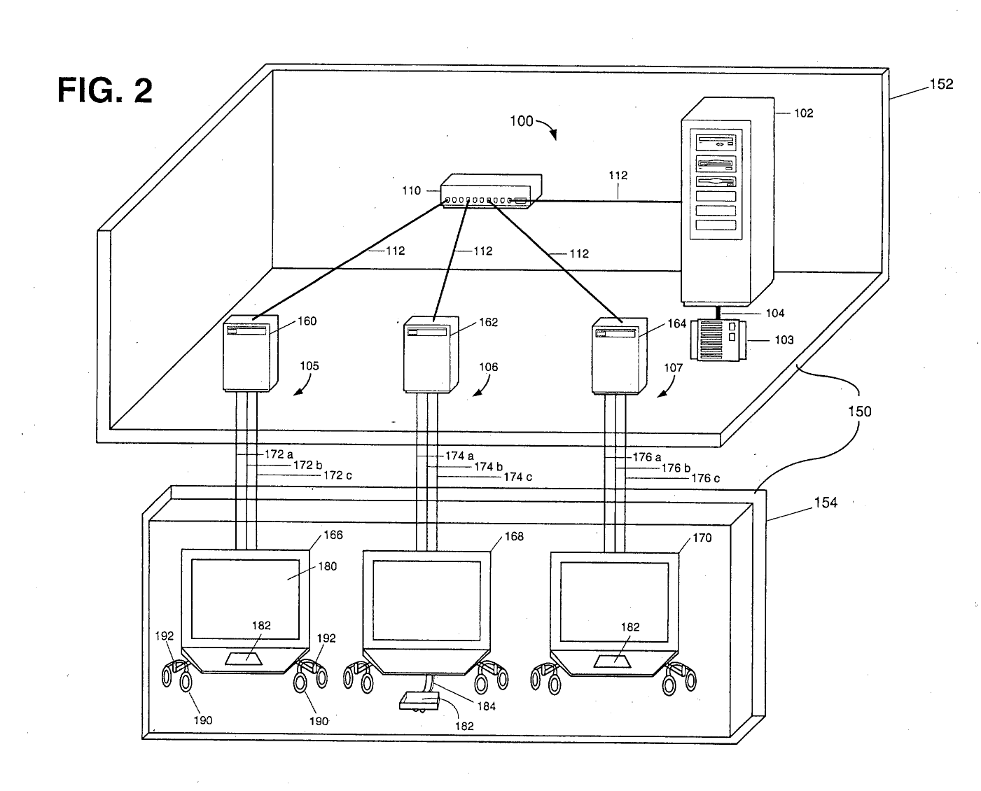

FIG. 2 depicts the in-store subsystem 100 installed at a retail location such as a music store 150. The retail location will typically have a back room 152 used for stock and other purposes with which the public is not concerned and to which the public does not have access. It will also have a sales floor, indicated generally at 154, with CD bins and other merchandising displays. The client computers 105, 106 and 107 are shown in FIG. 2 as comprising central processing units 160, 162 and 164, connected to user interface units 166, 168 and 170, respectively, by respective cable sets 172, 174 and 176, described in more detail below.

The in-store server 102, and its associated client computer central processing units 160, 162 and 164, switch 110 and ethernet network cables 112, are located in the back room 152 in the present embodiment. Some or all of these components might be located under a CD display bin or at other parts of the music store 150. However, it will generally be more convenient to have these components in one central location, away from the sales floor, for security and ease of maintenance. As noted above, the in-store subsystem may include more than one server and associated client computers. Only one is depicted in FIG. 2 for ease of illustration and description.

In the present embodiment, the user interface units 166, 168 and 170 can be one of two types. In a typical embodiment, all of the interface units in a particular store would most likely be the same, but both types are shown in FIG. 2 for illustrative purposes.

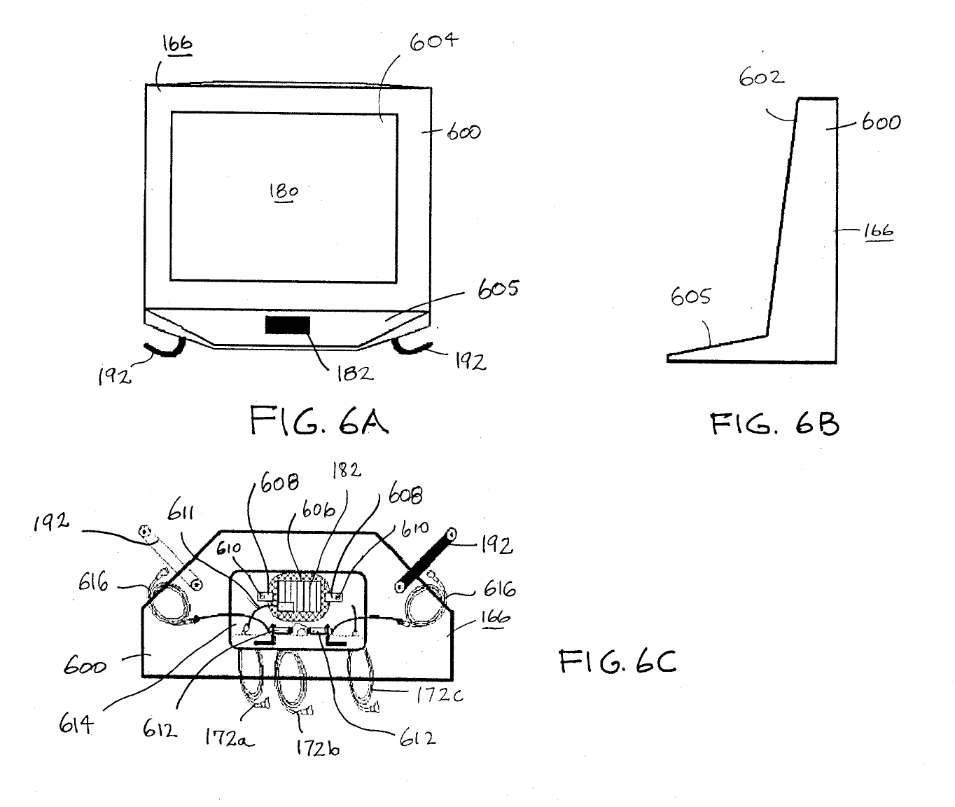

Interface units 166, 168 and 170 have the same monitor 180, which is typically a flat panel display such as a Viewsonic VE-150 Flatpanel LCD (liquid crystal display) monitor with a 15″ screen. To make the presentation to the customer as attractive as possible, the monitor is flush mounted into a facade of the CD bin, a wall of the store behind the CD bin, or other structure close by. This mounting can most advantageously be made using a custom enclosure, such as that described below in connection with FIG. 6. It is an aspect of the invention that the interface unit can be seamlessly integrated within the store fixtures, unlike known bulky kiosk displays.

Each interface unit has an input device, which can be a conventional computer mouse. However, in the present embodiment the input device is a Cirque Glidepoint TSM-802 touchpad device 182. The touchpad 182 permits inputs to be made by moving a finger across a small surface on the touchpad to cause a cursor to traverse the screen of the monitor 180. A single “tap” on the touchpad is interpreted by the operating system software as an input click from a conventional computer mouse. In an alternate embodiment, the touchpad could include at least one button, actuation of which by clicking would be interpreted as an input to the application software. Any such type of actuation is referred to herein by the familiar term “clicking on” information displayed on the screen to effect an input to the computer.

In one embodiment, depicted in connection with interface units 166 and 170, the touchpad 182 is mounted flush into an apron of a custom enclosure containing the monitor. (See FIG. 6.) This places the input device immediately below the monitor screen and provides an attractive, self-contained interface unit.

In another embodiment, represented by interface unit 168, the touchpad device 182 is mounted on a custom bracket 184 attached to the CD bin or other proximate structure, in a position for use by the customer as he or she approaches the CD bin.

Alternatively, a touch-activated monitor can be used as an input/output device. However, generally such monitors are not as reliable as a separate point-and-click type device such as a mouse or touchpad, and therefore are more likely to raise maintenance issues and cause customer frustration. However, as their reliability increases and their cost decreases, touch-activated LCD panels will be a practical alternative to the separate input devices described herein.

The user interface unit 166 further includes a listening device comprising one or more sets of stereo headphones 190 for listening to the CD track supplied from the client computer CPU 160. This permits the same CD to be heard by multiple users simultaneously, which is advantageous if shoppers have come to the store in pairs or in a group. Often, the music listening experience is enhanced if it is shared with others, and the present system provides that capability. Headphone brackets 192 removably hold the headphones 190 when they are not in use.

As noted above, each CPU 160, 162, 164, etc., communicates with its associated interface unit 166, 168, 170, etc., over respective cable sets 172, 174, 176, etc. Each of these cable sets has three cables, denoted by the suffixes “a,” “b” and “c.”

The cables 172a, 174a and 176a are video cables that transmit video information to the interface units' monitors. They are standard 10-foot, 15-pin DIN video cables, with extensions of like cables if necessary because of the distance to the interface unit.

The cables 172b, 174b and 176b transmit instructions from the touchpads 182 to the client computers' CPUs. They are convention PS-2 mouse cables.

The cables 172c, 174c and 176c are audio cables. Each incorporates generic cabling into a custom-built connection that uses a conventional terminal for connecting at one end to the audio output of each client computer's audio output, and a special splitter at the other end that provides multiple standard headphone jacks in the interface unit custom enclosure. This provides for listening by more than one user, and also permits easy access by store employees to enable headphone replacement without disturbing the client computer's central processing unit.

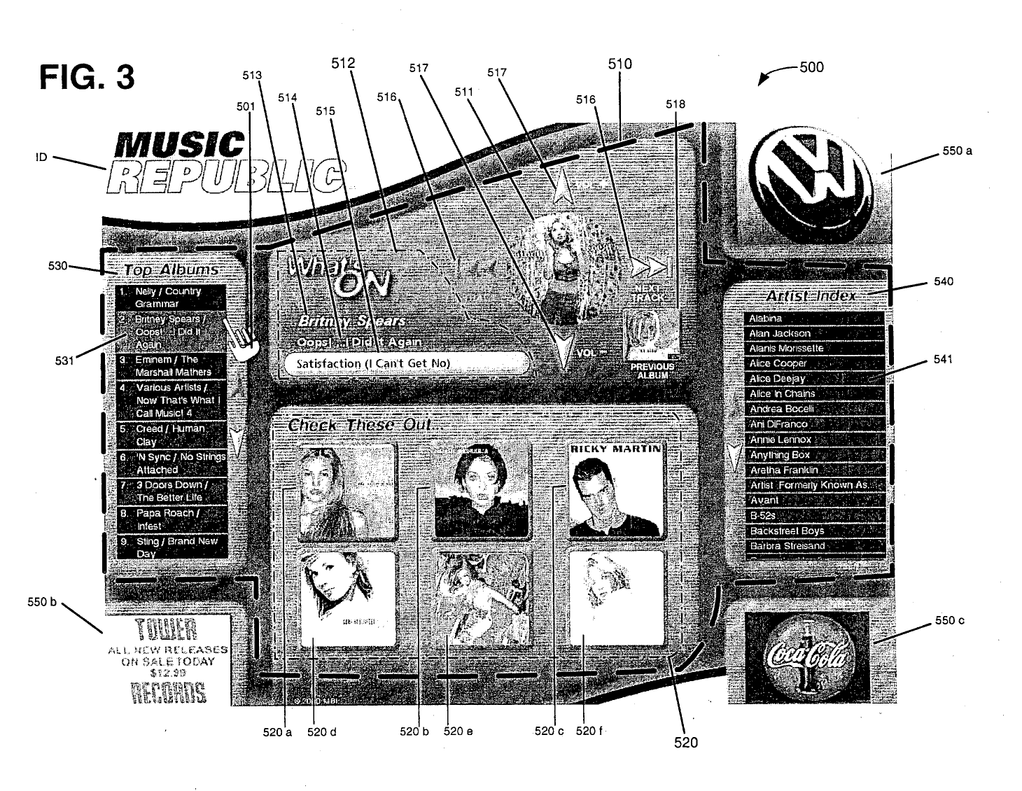

The operation of the system will be described first from the standpoint of the screen 500, shown in FIG. 3, that is displayed on a user interface monitor 180 to enable the user to access the various features of the system. It will be understood that each client computer and user interface operates in the same fashion. In the following discussion it will be assumed that the in-store subsystem 100 has obtained from the central information repository 200 all of the information to be provided to the client computers 105, 106, 107, etc. The manner by which that information is transferred to the in-store subsystem is discussed after the discussing the operation of the in-store subsystem.

It will be appreciated that the client computer is under the control of software, stored on the hard drive of the CPU 160, for interpreting commands transmitted to the CPU over the cable from the touchpad input device 182 as it is manipulated by the customer. In turn, the in-store server 102 and the client computer CPUs communicate through the switch 110 and over the ethernet cables 112 under the control of software stored on their hard drives. Such software, including that controlling the operations described below by which the client computer and the in-store server operate the in-store subsystem, is well within the ability of one skilled in the art to provide from this description.

The configuration and composition of the screen 500 is another important aspect of the invention. It will be appreciated as this discussion proceeds that the screen provides a great deal of information, while still making the user's navigation through the information available to him or her very intuitive. One way the intuitive “feel” of a screen according to this embodiment of the present invention is enhanced is by avoiding a screen that employs multiple “pages” or completely different screens that appear to the user after certain inputs. Such a navigational scheme can be very confusing, and often users are unsure how to return to a particular screen that they were previously viewing.

The screen 500 is displayed when the user has selected a particular CD using the cursor 501 under the control of the touchpad 182. The client CPU retrieves from its hard drive information about the CD, namely the artist, the track identifications, etc., as well as any associated advertising, promotions or animation, associated album reviews or commentaries, and the identity of six related albums.

The client computer's CPU also retrieves from the in-store server 102 the audio tracks from the selected CD. The compressed audio data is provided to the client CPU at 128 kilobits per second, as discussed above. The compressed audio data is provided to the codec (an acronym for “compression/decompression”) algorithm under the control of the BeOS operating system software on the client CPU. The codec decompresses the information to two channels of 44 kHz audio signals and provides it to the sound-reproduction software at an average rate of 352,800 bytes per second (1 byte=8 bits). The BeOS sound player uses the BeOS mixer to play back the audio file through the client computer's CPU, which provides it to the headphones 190 for listening by the customers.

The first track from the selected CD begins to play. While the CD is playing, the monitor 180 displays the screen 500. An information/control section 510 of the screen, outlined by a bold dotted line, relates to the customer's selections. It will typically include an image 511 of the cover of the CD currently playing. This is the image scanned in by the scanner 206 and provided to the in-store subsystem by the proprietor to the subscribing retail store. This image is animated, in that it appears to rotate 360 degrees in a clockwise direction, thus suggesting a CD that is playing. This animation is accomplished by software resident on the client CPU.

This screen section further includes an identification portion 512, outlined by a phantom line, that lists the name of the artist 513 and the title of the CD 514, as well as the title of the track therefrom 515, to which the customer is currently listening.

The screen section 510 also includes controls for the customer, such as “buttons” 516 that permit the customer to browse through the tracks on the current CD by using the touchpad to move the cursor 501 to and then click on “Prev. Track” or “Next Track.” Other buttons 517 enable the customer to adjust the volume in a similar manner. A previous selection portion 518 of this information/control screen section 510 displays the previous CD selected by the customer. The user/customer can click on this portion of the screen to recall the previous selection for playback.

A related-CD portion 520 of the screen, outlined by a phantom line, displays images 520a, 520b, 520c, 520d, 520e and 520f of related CD titles that the customer might find of interest in view of his or her interest in the current selection playing. The list of related CDs is generated by the in-store server 102. The customer can choose any one of these CDs to listen to by clicking on its image using the touchpad, as described above. Any time the customer makes a new selection, either from this portion of the screen or another as described elsewhere, a related-CD algorithm is used to generate a different list of alternate selections.

The way in which the six related CDs is chosen is an important aspect of the present invention. That choice is made by an algorithm that makes a sophisticated correlation among a large amount of information about each CD included in the system. The algorithm is also capable of changing the six CDs related to a particular CD based on the history of choices made by users of the system, as described below. The generation of a list of related selections enables the customer to browse the entire database of selections in a more focused manner.

The related-CD list can also be a marketing tool for the store in which the subsystem is located. In that connection, the list of related CDs generated by the algorithm would be manually overridden to include one or more CD from the store's older inventory that the store owner would like to promote. Of course, those CDs could be included in the listing portion 530 and would be in the available-CD portion 540 of the screen described below, but they could be more actively promoted by including one or more of them as CDs related to appropriate other CDs in the store's more current inventory.

The listing portion 530 of the information/control section 510 lists CDs 531 that the particular retail store is featuring. For example, they may be CDs that are on sale, CDs on popular record charts or radio airplay charts, or the most selected or listened to CDs on the system, as determined by monitoring software used by the in-store system or central repository. As before, the customer can choose any one of these CDs to listen to by clicking on its image using the touchpad, as described above. If the customer makes a new selection via this featured-CD screen portion, it is immediately played by the system and the related-CD application software generates a different list of alternate selections for display in the screen portion 520.

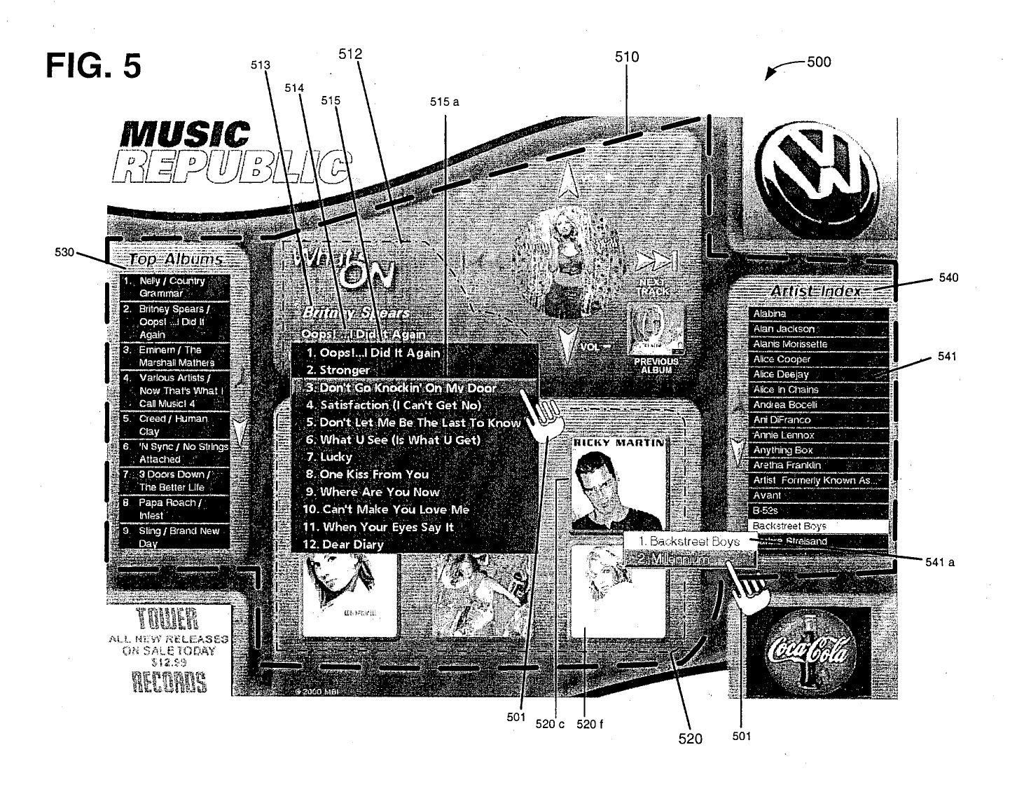

In the example depicted in FIG. 5, the user has moved the cursor 501 to the Britney Spears CD “Oops! . . . I Did It Again,” and the track therefrom named “Satisfaction (I Can't Get No)” is playing. FIG. 3 shows the cursor 501 on that selection, which is thereby highlighted by changing its text and background colors (say from yellow text on a black background to yellow text on a dark red background), thus increasing its contrast and brightness as compared with the surrounding area in a conventional fashion.

An available-CD portion 540 of the screen section 510 lists all of the CDs 541 available on the in-store subsystem's server. Preferably, this list is an alphabetical listing of all of the artists under whose name each CD was released, since that is the manner in which most consumers identify particular music selections. This section alternatively could be a listing by genre, upon selection of one of which a list of artists within the genre replaces the genre list. The screen portion could enable a user to display different genres by providing screen “buttons” as discussed above. Other schemes for providing access to the store's CD inventory will be apparent to those skilled in the art.

As before, the customer can choose any one of these CDs to listen to by clicking on it using the touchpad, as described above. If the customer makes a new selection via this index screen portion, the related-CD application software generates a still different list of alternate selections for display in the screen portion 520.

An advertising section of the screen includes screen portions 550a, 550b and 550c. As noted above, it is an important feature of the invention that the displayed advertising can be changed depending on the selection currently playing. As noted above, the advertising may be animated. This advertising is that which was input into the system by the proprietor, as described above in connection with the description of the central information repository.

In the screen 500 depicted in FIG. 3, the portions 550a and 550c are reserved for the targeted advertising. By way of example, the image in the portion 550a might be 200×160 pixels in size, and the images in the portions 550b and 550c might be 160 pixels×120 pixels in size. The portion 550b is reserved for the logo of the retail store in which the system is installed or for any image the store owner desires, such as store promotions. It may or may not be animated.

A portion ID of the screen 500 may be reserved for permanent display of desired advertising, such as the logo of the system proprietor or the retail store. It could also be used for targeted advertising instead.

In one embodiment of the system, the additional information input through the system represented by the computers 212 shown in FIG. 1 can be displayed in the screen portion 540. When a CD is selected for play, the portion 540 changes to include three screen “buttons” (not shown) for providing the user with a choice of information. One button would provide access to the CDs available in the store, as shown in FIG. 3. A second button could be labeled “Album Review,” and clicking on it would substitute in the screen portion 540 the reviews of the selected CD input as discussed above. A third button could be labeled “Latest News,” which would substitute in the screen portion 540 a display of recent information about the selected CD, about the artist of the selected CD, or the like. That information would be input at the repository in the same fashion. The news items could be updated by the system proprietor frequently using the telecommunications link from the central repository, thus essentially providing a news magazine available at the interface unit.

Typically, the overall system 10 will be operated by a proprietor who assembles the information for subscribers who own or operate retail outlets with in-store subsystems 100 installed therein. The proprietor will maintain a database of music titles in MP3 or other digital format, album cover graphics, advertising or videos, and critics' and other commentators' reviews and recommendations, as described above.

All of this data is stored on the hard drives of the repository server 202. A suitable database program for the information is Oracle 8, which is sold by Oracle Corporation and is an industry standard for multimedia databases. The repository server also includes application software included in common gateway interface scripts, used for data entry and editing, checking data integrity and managing files. In one embodiment, a flat-file system is used in running the in-store server, instead of having the actual database thereon.

In such an embodiment, data processing and manipulation relating to the CDs and their associated information occurs on the central repository server. By placing a copy of the output of such data in a flat file system on the in-store server, data access is much quicker. Accordingly, the role played by the database in the in-store server is greatly reduced since this part of data manipulation ips not in real time. Any data collected by the in-store server is subsequently sent back to the repository server and incorporated in the next iteration of output data.

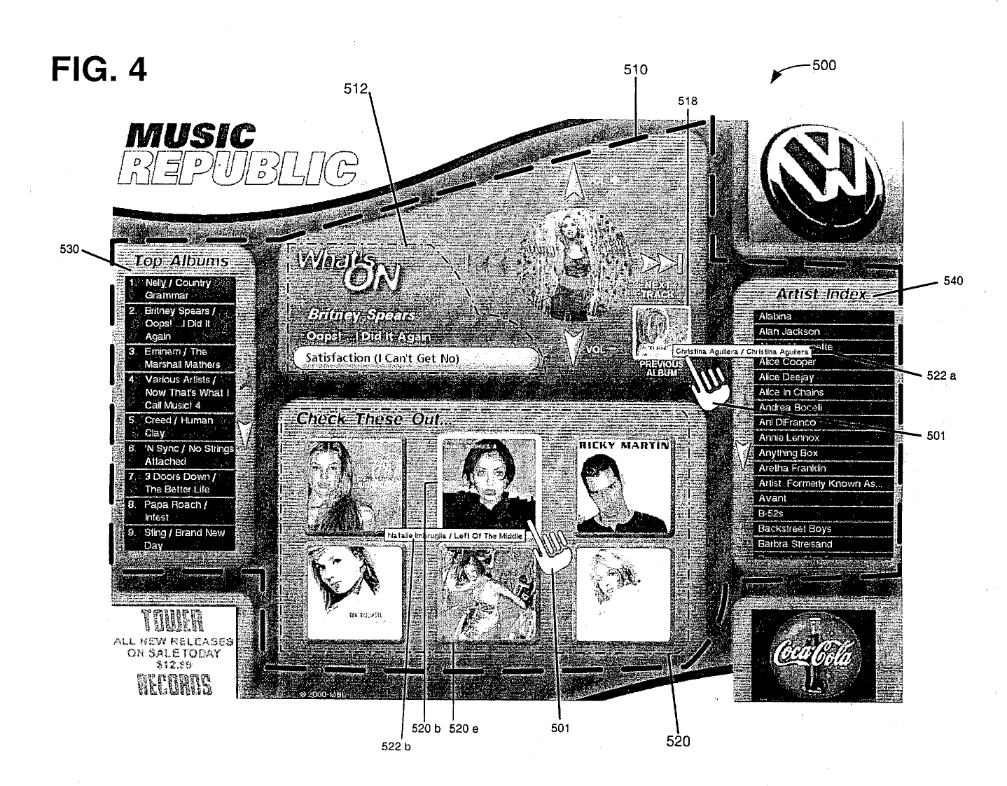

FIG. 4 illustrates another feature of the screen 500. The screen cursor 501 can be brought to rest over certain items displayed on the screen to show additional information about the particular displayed item. For example, in FIG. 4 the cursor 501 is resting on the previous selection depiction 518. When the cursor is in that position, a small information strip 522a appears to give the name of that selection. This gives the user an additional visual clue regarding his or her previous selection. As another example, if the cursor 501 were brought to rest over the depiction of related CD 520b, the CD's name would appear in a small strip 522b. It will be understood that two cursors are depicted in FIG. 4 for illustrative purposes; only one cursor 501 is visible at any one time on the screen.

FIG. 5 illustrates another feature of the invention, namely the ability to facilitate browsing the music store's inventory without complicating the amount of visual information available to the user at any one time.

In one example, if the user clicks on the track title identification 515, a pop-up menu 515a appears with all of the tracks available for the current selection. It should be noted that this aspect of the invention provides particular versatility to the user's capability for browsing music selections. For example, if the current selection is a multi-CD collection, the pop-up menu 515a would include all of the tracks from the entire collection. The user clicks on the desired track, and it is played over the headphones 190. That is, all of the tracks from an entire collection are available for immediate listening in their entirety without requiring a physical change of CDs in a CD player.

As another example, if the user clicks on a CD from the artist list 541, and more than one CD of the selected artist is available, a pop-up menu 541a appears with all of that artist's available titles. The user then clicks on the desired CD and the first track therefrom begins playing, and the CD becomes the current selection in accordance with the discussion above. As with FIG. 4, it will be understood that two cursors are depicted in FIG. 5 for illustrative purposes only.

The client computers also have an idle mode. It is provided in the event that a track fails to start playing because the in-store server is currently malfunctioning, communication therewith has failed, or a selected audio file is not present on the server or is damaged. The idle mode may also be entered at the end of an audio track. In either case, the system waits for a given time, say 10 seconds for further customer input. The monitor may display an appropriate error message accompanied by an audio clue, such as a short tone, to indicate to the user that there is a problem and that he or she should try another selection.

If no further customer input occurs, the system determines if any customer input has occurred recently, say within the last 60 seconds. If neither activity is detected, the system may enter the idle mode, although if access to the server is available, the system could be programmed to play the next track from the current selection and reenters normal browsing mode with screen 500 on the monitor.

In a first idle mode, idle-mode advertising, preselected by either the store or the system proprietor, is retrieved from the client CPU and displayed on the monitor 180. After a given period of time, say 20 seconds, has passed, the system enters a second idle mode in which it selects at random an audio track for playback. A screen like that shown in FIG. 3 is displayed during this time.

In one embodiment, this idle mode plays random or pre-selected CD tracks, interlaced with full-screen advertising images for 20-30 seconds. This provides another advertising opportunity, while at the same time providing a visual indication to those passing the interface unit that the system is available for use. The advertising could be related to particular CDs available for playback.

During either idle mode, the browser continuously scans for user input from the touchpad 182. If user input in the form of a cursor movement is detected at any time while the system is in the idle mode, the system enters the active mode discussed above in connection with FIGS. 3-5.

It will be understood that the above described idle modes are exemplary only. Other routines are possible when an interface unit has not been used for a particular length of time or the system is down for some reason.

Details concerning the related-CD algorithm will now be described.

When the audio information is extracted from a CD, certain identifiers are associated with it, as mentioned above. In addition to that information, a unique set of descriptive categories is also assigned to each CD.

In one embodiment, the categories might include the following:

Album information, such as album name, release date, original recording date, record label and publishing company.

Production information, such as recording date, recording studio(s), recording engineer(s), and assistant recording engineer(s), mastering date(s), mastering studio(s), mastering engineer(s), and assistant mastering engineer(s).

Artist information, such as name, alias(es), band name, band members names and the instruments they play, and other information about them such as their birthdates, spouses' names, citizenship, dates of death, etc.

Socio-cultural information, such as identification with historical events (the Vietnam War, for example) or cultural events (such as Woodstock), etc.

Genre information.

Review information, such as favorable or unfavorable reviews by a particular critic, etc.

Each CD is then associated with a number of sort files, the contents of which are represented by database tables and fields. An algorithm uses a match-up script to sort through these fields, match common related fields and output information related to each field.

Examples of fields might be CDs released within ten days of each other, CDs sharing one or more categories, such as genre, CDs by the same artist, CDs produced by the same producer, CDs associated with the same socio-cultural event, etc. Each sort field is assigned a particular weight. For example, a match of the same artist would be given more weight than a match of two CDs released within ten days of each other. So, for a particular CD, a list of several, say 30, other CDs are matched therewith, and that association information is stored for each CD. The client CPU then chooses six of those CDs at random for display as being related to the selected CD being played back.

It will be appreciated that one advantage of using an algorithm for selecting related CDs is that it enables a dynamic aspect to be built into the selection algorithm. Accordingly, the six related CDs for a particular CD will change over time.

That is, as certain CDs are selected by users when displayed in the related-CD screen portion, that information can be used to weight those CDs for more frequent display. For example, if 50% of users over time who listened to selected CD “X” for more than a given length of time, say three minutes, then followed that selection with CD “Y” from the related-CD listing, that information is included in the information associated with CD “X.” Accordingly, over time CD “Y” becomes more likely to be displayed as an CD related to CD “X.”

As a final check, the system proprietor checks the list of related CDs to ensure that the algorithm did not produce any anomalous selections. That is, if the algorithm associates one CD with another that is inappropriate, the algorithm can be overridden so that the inappropriate CD will not be displayed as a related CD.

It will thus be appreciated that an in-store subsystem in accordance with the present invention enables a customer to access plural discrete groups of digital data, here individual tracks from plural CDs, which digital data represents entertainment content from a medium, namely the CDs, on which it was previously recorded. A server computer is used to store the groups of data so that they can be accessed individually without regard to the fact that they may have been originally recorded in on different CDs. At least one, and preferably plural, client computers communicate with the server computer under the control of software to permit a user to specify a particular CD track and have it played on a user interface unit, again without regard to the particular CD on which it was originally recorded.

In accordance with another aspect of the invention, the information stored on the hard drives of the in-store servers 102 and client computers 105, 106, 107, etc., is periodically updated by the system proprietor. The proprietor and the subscribers have a number of choices regarding how this update is accomplished.

One way of updating a subscriber's in-store subsystems is to download the information on the repository server 202 onto one or more storage media S such as a CD-ROM or DVD disc, depicted schematically in FIG. 1. The information for updating the in-store system 100 is stored on the medium S, which is then physically shipped to the store location.

Using software pre-installed on the in-store servers 102 by the proprietor, the subscriber uses the information on the medium S to update and replace the information on the in-store subsystem. For example, new music CDs can be included along with instructions to delete certain other CDs then residing on the store's servers 102. In addition, corresponding album cover graphics, new advertising, updates to the software used to generate the list of related CDs displayed on the monitor as discussed above, etc., will be included on the storage medium.

The in-store servers 102 will then provide the necessary information to the client computers 105, 106, 107, etc., for storage on their respective hard drives, all under the control of pre-installed software from the proprietor of the system. In the present embodiment, the information from the proprietor will first be loaded onto each in-store server 102 in the subscriber's retail store. Suitable utility software stored on the server 102 will store the new music files on the server's hard drive. The new CD cover graphics and advertising files will be transmitted to the client computers 105, 106, 107, etc., through the switch 110 and the ethernet cables 112, for storage on the client CPUs 160, 162, 164, etc. The CD cover files and advertising files are stored on each client computer's hard drive to enable the rapid access required to effect the display of different images in accordance with the above discussion.

Alternatively, the information on the storage medium can instead be transmitted over a suitable telecommunication lines L1 and L2. This alternative would be more feasible for large chain music retailers that might better afford more expensive high-speed, broadband telecommunications lines, without which the transfer of these large amounts of information involved would be impractical.

As another alternative, the information transfer could be a hybrid of those two methods. For example, smaller updates to the in-store systems involving lesser amounts of information, such as new reviews of a CD or a limited number of new CDs and associated information that a store would like to have sooner for marketing purposes, can be transmitted by telecommunications. Then, more extensive updates, such as scheduled replacements of large parts of the store's inventory, can be accomplished using a portable storage medium.

The architecture of the present system enables an entire store's inventory to be made available at any given store. It is well within the capacity of any in-store subsystem to have available the entire 15,000 to 25,000 CDs a large music store might have in inventory. However, different stores will undoubtedly have different inventories based factors such as their target markets or individual preferences of their music buyers. Given that upwards of 250,000 CDs are in “print” as of this writing, which number is continuously increasing, and that the present system uses a great deal of information other than CD tracks, it is simply not practicable to store on every subscribing in-store subsystem all of that information.

However, it is possible to contain all of that information at the central repository. Each in-store subscriber can then specify which CDs it would like to have resident on its subsystem, and the system proprietor can provide it from the available information.

Referring to FIGS. 6A, 6B and 6C, an enclosure 600 for a user interface unit such as unit 166 is depicted.

The enclosure 600 has a body portion 602 with a flat front having an opening 604 that matches the size of the display area of the flat panel monitor 180 housed within the enclosure. The enclosure includes an apron 605 that presents a surface at the bottom of the front of the enclosure. An opening 606 in the apron provides access to the operative surface and buttons of the touchpad 182. The headphone brackets 192 extend obliquely from the ends of the apron 605 and are secured to the underside of the enclosure by screws 606 (not shown).

The touchpad 182 is mounted inside a recessed holder 606 by mounting clips 608 secured by screws 610 to the underside of the apron 604. The touchpad is electrically connected to the cable 172b by suitable wiring 611.

Headphone jacks 612 are also mounted inside the enclosure. A suitable splitter cable (not shown) connects the headphone jacks to the audio cable 172c. An opening in the underside of the enclosure permits the headphone cables 616 to be connected to respective jacks 612. (The headphones are omitted from FIG. 6 ease of illustration.) Not connecting the headphone jacks directly to the client CPU provides additional protection to the headphone cables. Those skilled in the art will recognize that the headphones may be wireless, in which case the cables 616 are not necessary.

The opening 614 is covered by an access door (not shown), which is mounted by a hinge to the bottom of the enclosure and locked in a suitable fashion. Typically, the key is provided only to the store manager or service personnel of the system proprietor.

The enclosure 600 is preferably made of Quarry Stone brand substrate material or DuPont Corian® methacrylate resin structural material. That material enhances the visibility of the enclosure, imparts a unique and distinctive look and feel, and has proven to be sturdy and easy to use in manufacturing the enclosure. It also provides good heat dissipation, thus minimizing the need for internal ventilation fans.

The use of such an enclosure provides a number of advantages. It will house any standard LCD flat panel display regardless of the mounting with which it is sold. Simply removing the actual display from its mounting enclosure enables most suitable monitor to be used in a uniform enclosure as described above. It is even possible to obtain discounts from monitor sources since only the display itself, without the usual mounting apparatus with which it us normally sold, will be needed. It also means that a group of in-store systems, say all of the stores of a retail chain of music stores, can have the same enclosure appearance, thus promoting brand identity.

The enclosure has numerous functional advantages as well. It provides a convenient manner of protecting the LCD display by using a ¼″ thick sheet of industrial strength plexiglass over the monitor opening 604. The LCD power switch and control settings can be secured within the enclosure. All internal wiring and other hardware is hidden from view and can be accessed only through the bottom opening 614.

It also provides all of the components needed by the listener in an integrated setting, thus providing additional visual clues as to the functions of the various components comprising the interface unit. That is, the touchpad housing is mounted immediately under the screen and is thereby physically associated with it. Thus, there will be less likelihood of confusion as to the touchpad's function on the part of a user approaching the unit. The same is true regarding the headphones. Since they are mounted right on the unit, the user will immediately recognize their function as a part of the system.

It will be appreciated that the system in accordance with the invention is not limited to use with CDs. It could be used to provide listening stations for audio tapes or previews of digital video discs, as well.

The present system also provides flexibility as to the source of the digital information made available for browsing. For example, it could be entertainment content downloaded directly from the internet. It could also include video games. In fact, the present invention has broad applicability in that it provides the capability of reorganizing large amounts of data, rearranging and sorting it, and then making it available in reorganized from for browsing.

The system has many uses and implications beyond its use as a CD browser in music stores. It is capable of reorganizing and presenting many different forms of entertainment content so that it is available in formats under almost total control of the listener. For example, a listener could create his or her own CDs or DVDs that include the same songs or other music pieces performed by different artists, instrumental excerpts by certain back-up performers, or movie soundtracks by a certain composer, just to name a few. Different sound processing could be added to the CDs or DVDs thus created, such as surround sound, different channel levels, etc. Any or all of the selections could be accompanied by reviews or other background information, and in the case of DVDs, combined with video information.

While preferred embodiments of the invention have been depicted and described, it will be understood that various modifications and changes can be made other than those specifically pointed out without departing from The spirit and scope of the invention, which is defined solely by the claims that follow.

What is claimed is:

1. A system for providing access to individual ones of plural discrete groups of digital data containing entertainment content, each said group of digital data representing a corresponding discrete group of entertainment content extracted in its entirety from a different medium, the system comprising:
a server computer for storing a plurality of said groups of digital data, said server computer being under the control of software for accessing each said group of digital data; and
at least one client computer communicating with said server computer for retrieving at least one said group of digital data therefrom, said client computer including an interface unit for reproducing said entertainment content from said retrieved group of digital data and being under the control of software for enabling a user to retrieve a specified said group of digital data.

2. A system as in claim 1, further comprising a plurality of said client computers.

3. A system as in claim 1, wherein each said group of digital data comprises an audio track extracted in its entirety from a compact audio disc, said server computer storing audio tracks from a plurality of said compact audio discs.

4. A system as in claim 3, wherein said interface includes:
an input device for specifying a selected said compact audio disc from which said retrieved audio track was extracted;
a listening device for reproducing said retrieved track extracted from said selected compact audio disc; and
a monitor for displaying visual information related to said selected compact audio disc.

5. A system as in claim 4, wherein said listening device comprises stereo headphones.

7. A system as in claim 6, wherein said listening device includes two sets of said stereo headphones.

8. A system as in claim 4, wherein said visual information is stored as digital data by said client computer.

9. A system as in claim 8, wherein said visual information includes digital graphic data representing a cover under which said selected compact audio disc is sold.

10. A system as in claim 9, wherein said visual information further includes video information associated with said selected compact audio disc.

11. A system as in claim 10, wherein said video information comprises advertising associated with said selected compact audio disc.

12. A system as in claim 10, wherein said monitor displays a screen including a controlling cursor and an information/control section having:
visual information regarding said selected compact audio disc and controls for controlling the reproduction thereof using said cursor;
a related-CD portion displaying information regarding a plurality of related said compact audio discs the audio tracks of which are stored on said server computer, said related compact audio discs being related in a predetermined manner to said selected compact audio disc, wherein the user can designate one of said related compact audio discs as said selected compact audio disc using said cursor;
a listing portion displaying a preselected list of said compact audio discs the audio tracks of which are stored on said server computer, wherein the user can designate one of said listed compact audio discs as said selected compact audio disc using said cursor; and
an index portion containing an index to all of said compact audio discs the audio tracks of which are stored on said server computer, wherein the user can designate one of said indexed compact audio discs as said selected compact audio disc using said cursor.

13. A system as in claim 12, wherein said related-CD portion displays said cover of each of six said compact audio discs the audio tracks of which are stored on said server computer.

14. A system as in claim 13, wherein said related compact audio discs are determined by a algorithm using a plurality of information regarding the entertainment content of each said compact audio disc the audio tracks of which are stored on said server computer.

15. A system as in claim 14, wherein at least one of said compact audio discs the audio tracks of which are stored on said server computer has associated therewith a pre-designated said compact audio disc, said pre-designated compact audio disc being displayed as one of said related compact audio discs when said at least one compact audio disc is said selected compact audio disc.

16. A system as in claim 14, wherein said system is installed in a music store and compact audio discs the audio tracks of which are stored on said server computer represents all of the compact audio discs in inventory at said store.

17. A system as in claim 16, wherein at least one of said compact audio discs the audio tracks of which are stored on said server computer has associated therewith a pre-designated said compact audio disc, said pre-designated compact audio disc being displayed as one of said related compact audio discs when said at least one compact audio disc is said selected compact audio disc.

18. A system as in claim 17, wherein said pre-designated compact audio disc is from old inventory of said store.

20. A system for providing access by customers of a retail store to individual ones of plural discrete groups of digital data containing entertainment content extracted from a different medium, the system comprising:
a central repository including:
a repository server computer for storing a plurality of said groups of digital data and auxiliary digital data containing auxiliary information related to each said group of digital data, said production server being under the control of software for associating each said group of digital data with said related auxiliary information,
means for generating said auxiliary digital data for storage by said production server computer, and
means for extracting said entertainment content from said different medium for storage as said groups of digital data by said repository server computer; and
at least one in-store subsystem for accepting said groups of digital data and said auxiliary digital data from said central repository, each said in-store subsystem including:
an in-store server computer for storing a plurality of said groups of digital data, said in-store server computer being under the control of software for accessing each said group of said digital data, and
at least one client computer communicating with said in-store server computer for retrieving at least one said group of digital data therefrom, said client computer storing said auxiliary digital data and including an interface unit for reproducing the entertainment content from said retrieved group of digital data and being under the control of software for enabling a user to retrieve a specified group of digital data, wherein said interface unit includes a monitor for displaying said auxiliary information associated with said specified group of digital data.

21. A system as in claim 20, wherein each said group of digital data comprises an audio track extracted in its entirety from a compact audio disc, and said interface includes:
an input device for specifying a selected said compact audio disc from which said retrieved audio track was extracted;
a listening device for reproducing said retrieved track extracted from said selected compact audio disc; and
a monitor for displaying visual information related to said selected compact audio disc.

22. A system as in claim 21, wherein said auxiliary information includes visual information comprising digital graphic data representing a cover under which said selected compact audio disc is sold and video information comprises advertising associated with said selected compact audio disc.

23. A system as in claim 22, wherein said means for generating said groups of digital data includes a device for extracting tracks of compact audio discs in a computer-readable format.

24. A system as in claim 21, including a plurality of said in-store subsystems.

25. A system as in claim 24, wherein each said in-store subsystem is capable of storing a different plurality of said groups of digital data and corresponding different said auxiliary digital data.

26. A system as in claim 22, wherein said auxiliary information includes text information associated with said compact audio discs, said information being displayed by said interface unit.

27. A system as in claim 20, wherein said means for generating said groups of digital data includes a device for extracting tracks of compact audio discs in a computer-readable format.

28. A user interface unit used in a system for providing access to individual ones of plural discrete groups of digital data containing entertainment content and related visual information associated therewith, said interface unit being under the control of software on a computer remote from said interface unit, said interface unit comprising:
a monitor for displaying visual information stored on said computer;
a listening device for reproducing said audio information stored on said computer;
a touchpad device having an inputting surface for providing signals to said computer for designating information for display on said monitor and for reproduction by said listening device; and
an enclosure having a body portion containing said monitor, an apron integral with said body portion mounting said touchpad input device with said inputting surface flush with an upper surface of said apron below said body portion, and a listening device mount holding said listening device in position for use, wherein said enclosure encloses said touchpad device and said monitor.

29. A user interface unit as in claim 28, wherein said listening device comprises at least one set of headphones and said listening device mount includes a bracket for holding said headphones.

30. A user interface unit as in claim 29, wherein said listening device comprises two sets of said headphones and said listening device mount includes two brackets for said sets of headphones.

31. A user interface unit as in claim 28, wherein:
said enclosure has a monitor opening through which a display screen of said monitor is viewed by a user, said monitor opening being covered by a sheet of material for protecting said display screen; and
said enclosure has an access opening at a bottom thereof for providing the sole manner of access to the interior of said enclosure, said access opening being secured in position by a locking device.

32. A user interface unit as in claim 29, wherein said enclosure is made of methacrylate resin structural material.
